(19) United States
(12) Patent Application Publication
(10) Pub. No.: US 2026/0024131 A1
(43) Pub. Date: Jan. 22, 2026

(54) SYSTEM AND METHOD OF DISTRIBUTED MONETIZATION OF COMMODITY-BACKED TOKEN

(71) Applicant: DHRUV PARIKH, Hamilton (CA)

(72) Inventor: DHRUV PARIKH, Hamilton (CA)

(21) Appl. No.: 18/982,149

(22) Filed: Dec. 16, 2024

Related U.S. Application Data
(60) Provisional application No. 63/672,928, filed on Jul. 18, 2024.

(51) Int. Cl. G06Q 30/0601; G06F 3/0484; G06F 3/14

(52) U.S. Cl. CPC G06Q 30/0643; G06F 3/0484; G06F 3/14; G06Q 2220/00

(57) ABSTRACT

The present disclosure relates to a system and a method of distributed monetization of a commodity-backed token. The system includes control circuitry configured to generate a first NFT based on the first input from the first user, associate a first merchandise corresponding to the first NFT, to the generated first NFT, display, in a user device associated with a second user, the first NFT with a detail of the associated first merchandise, receive, from the user device associated with the second user, a second input associated with a purchase of the first merchandise corresponding to the first NFT, generate and display, based on the received second input, a notification in a user device associated with a third user, wherein the notification includes details of the purchase of the first merchandise corresponding to the first NFT by the second user, and calculate a commission amount for the first user.

### CROSS-REFERENCE TO RELATED APPLICATION

This application claims the benefit under 35 U.S.C. & 119(e) of a U.S. Provisional Application Ser. No. 63/672,928 filed on Jul. 18, 2024, which is hereby incorporated by reference in its entirety.

### TECHNICAL FIELD

The present disclosure provides a system and a method of distributed monetization of a commodity-backed token.

### BACKGROUND

In the rapidly evolving digital landscape, traditional NFT marketplaces often suffer from a lack of integration with merchandise sales, which can significantly limit the revenue potential for creators and diminish the overall user experience. Many of these platforms focus solely on the trading aspect of NFTs, leaving creators with limited avenues to monetize their work beyond the initial sale of the digital asset. This singular focus on NFT trading means that creators are often unable to capitalize on additional revenue streams that could be generated through the sale of associated physical or digital merchandise.

The complexity of monetization further complicates the situation for creators and brands. Managing separate platforms for NFT sales and merchandise can be cumbersome and inefficient, creating unnecessary hurdles that can impede the ability to generate sustained income. This fragmented approach forces creators to juggle multiple interfaces and systems, which can lead to a disjointed and less effective monetization strategy. Without a cohesive solution that integrates both NFT and merchandise sales, creators may struggle to maximize their earnings and engage with their audience effectively.

User engagement also suffers in the absence of integrated solutions. When NFT marketplaces do not offer seamless ways for users to interact with their favorite creators and brands beyond the initial NFT purchase, significant opportunities for deeper engagement and loyalty are missed. Fans and collectors who purchase NFTs may wish to support their favorite creators further by buying related merchandise, but the lack of integration makes this process unnecessarily complex and fragmented. This gap not only affects user satisfaction but also hinders the growth of a vibrant and interactive community around the creators' work.

While some platforms have attempted to address these issues, they often come with significant drawbacks or deficiencies. For instance, some solutions provide separate platforms for NFT trading and e-commerce, forcing creators and users to navigate between multiple interfaces. This fragmentation can lead to a disjointed user experience, making it harder for users to engage consistently and reducing the likelihood of widespread adoption. Moreover, the limited integration seen in some platforms means that creators have fewer options to bundle merchandise with NFTs, or for users to seamlessly purchase associated products.

Existing solutions also tend to suffer from complex monetization models that are not user-friendly. Creators may find it challenging to earn revenue from merchandise sales, and users may face difficulties participating in presales or other monetization opportunities. This lack of simplicity and accessibility can deter both creators and users from fully utilizing the platform's potential.

Additionally, the platform fails to cater limitations of the creators by offering limited products backed by NFTs that the creator can make, thus, limiting the revenue potential of the creator that can be earned in the form of commission or royalty. For instance, there is no platform that may enable a third-party manufacturer to offer any commodity with imprinted NFT that is created by the creator in return for a royalty to the creator of the NFT. Hence, increasing the revenue potential of the creator.

Therefore, there is a need for a system and a method that may overcome the aforesaid limitations.

### SUMMARY

This summary is provided to introduce a selection of concepts in a simplified form that are further disclosed in the detailed description of the invention. This summary is not intended to identify key or essential inventive concepts of the claimed subject matter, nor is it intended to determine the scope of the claimed subject matter.

The present disclosure provides a device, system, and method for NFT-based merchandise sales to enable a creator or an owner of the NFT to increase the revenue potential by earning a commission or royalty income. The device, according to the first aspect of the present disclosure, comprises control circuitry or processor. The control circuitry is configured to generate a first NFT based on a first input from a first user. The control circuitry is further configured to generate a first image comprising images of one or more merchandise having the first NFT on images of each of the one or more merchandise. The control circuitry is further configured to control a display device of a second user device to display the generated first image. The control circuitry is further configured to receive a second input from the second user device to select at least one merchandise of one or more merchandise. The second input is based on an operation of the second user on the first image. The control circuitry is further configured to generate information associated with the selected at least one merchandise by the second user. Accordingly, the control circuitry is configured to control a display device of a third user device to display the generated information associated with the selected at least one merchandise.

In another aspect of the present disclosure, the system for NFT-based merchandise sales, comprises a server connected to one or more user devices through a network. The server is configured to configure an application interface within the one or more user devices to receive an input from the users and present information to the user based on the received input. The server further comprises control circuitry or processor. The control circuitry is configured to generate a first NFT based on a first input from a first user. The control circuitry is further configured to generate a first image comprising images of one or more merchandise having the first NFT on images of each of the one or more merchandise. The control circuitry is further configured to control a display device of a second user device to display the generated first image. The control circuitry is further configured to receive a second input from the second user device to select at least one merchandise of one or more merchandise. The second input is based on an operation of the second user on the first image. The control circuitry is further configured to generate information associated with the selected at least one merchandise by the second user. Accordingly, the control circuitry is configured to control a display device of a third user device to display the generated information associated with the selected at least one merchandise.

In another aspect of the present disclosure, a method for NFT-based merchandise sales comprises, using control circuitry or processor, generating a first NFT based on a first input from a first user, generating a first image comprising images of one or more merchandise having the first NFT on images of each of the one or more merchandise, controlling a display device of a second user device to display the generated first image, receiving a second input from the second user device to select at least one merchandise of one or more merchandise, The second input is based on an operation of the second user on the first image. The method further comprises generating information associated with the selected at least one merchandise by the second user, and accordingly controlling a display device of a third user device to display the generated information associated with the selected at least one merchandise

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 shows an exemplary system 100 for NFT-based merchandise sales, according to an embodiment of the present disclosure.

FIG. 2 is a block diagram that illustrates exemplary implementation of a system 100 for NFT-based merchandise sales, according to an embodiment of the present disclosure.

FIG. 3 is a block diagram that illustrates exemplary user device of the system, according to an embodiment of the present disclosure.

FIG. 4 is a flowchart of a method of creating and offering of an NFT and associated merchandise, according to an embodiment of the present disclosure.

FIG. 5 is a flowchart of a method of distributing of revenue between the creator of NFT (first user) and manufacturer of merchandise (third user), according to an embodiment of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware and or by human operations.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc, read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a”, “an”, and “the” includes plural reference unless the context clearly dictates otherwise. Also, as used in the description herein, the meaning of “in” includes “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and willfully convey the scope of the invention to those ordinary skill in the art. Moreover, all the statements herein reciting embodiments of the invention, as well as specific examples thereof, are intended to encompass both structural and functional equivalent thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claim.

The present disclosure relates to an NFT-based merchandise trading. More particularly, a device, a system, and a method of distributed monetization of a commodity-backed token. For instance, the system is provided to enable the NFT creator or artist to increase a revenue potential of the work by earning in a form of royalty or commission. The system is integrated with a virtual platform which is a combination of NFT and e-commerce offering NFT and associated merchandises. The system configures an application interface of the virtual platform within the user device of the creator or owner of the NFT to enable the creators or owners to create and offer NFTs over the platform. The system further configures an application interface of the virtual platform within the user device of the conventional users of the platform to explore the platform and NFT's, and purchase a merchandise associated with the NFTs. The system further configures an application interface of the virtual platform within the user device of the merchandise manufacturers to receive an order information including the details of the selected NFT and the associated merchandise, and accordingly deliver a merchandise to the buyer.

Therefore, the system enables manufactures to offer difference merchandises with imprinted or embossed NFT created by the creator. The user of the platform for whom the price of actual NFT is costly, may order the associated merchandise on the platform. The system generates notification regarding order of merchandise from the manufacturer. Further, the system calculates a royalty or commission amount for the creator and accordingly distribute the amount from the user between the creator of NFT ad manufacturer of merchandise.

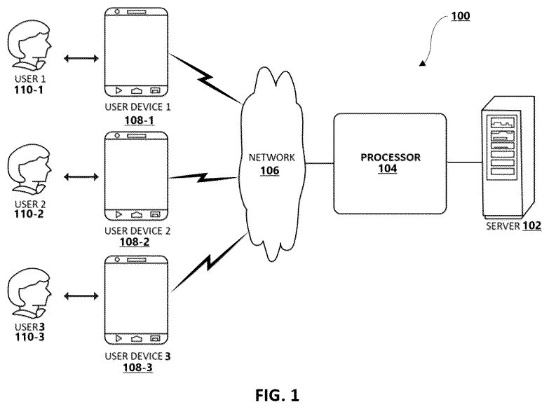

FIG. 1 shows an exemplary system 100 for NFT-based merchandise sales, according to an embodiment of the present disclosure.

According to the first aspect, the system 100 comprises a server 102 having a processing circuitry or a processor 104 coupled with one or more user devices 108-1, 108-2 . . . 108-N (which may be collectively referred to as the user devices 108 and individually referred to as the user device 108-1, 108-2, or 108-3, hereinafter) through a network 106. The one or more user devices 108-1, 108-2 . . . 108-N may include a first user device 108-1, a second user device 108-2, and a third user device 108-3. The one or more user devices 108-1, 108-2 . . . 108-N may be associated with the one or more users 110-1, 110-2 . . . 110-N (which may be collectively referred to as the user devices 110 and individually referred to as the user device 110-1, 110-2, or 110-3, hereinafter). The one or more users 110-1, 110-2 . . . 110-N may include a first user 110-1, a second user 110-2 and a third user 110-3. The first user 110-1 may include a creator or an owner of the NFTs. The second user 110-2 may include a conventional user of the platform. The third user 110-3 may include manufacturers for the merchandise on the platform. It is to be noted that, for the sake of simplicity, the creators, the users, and the manufacturers are referred to as the first user 110-1, the second user 110-2, and the third user 110-3, respectively. However, the creators, users, and the manufacturers may be any of the first user 110-1, the second user 110-2, or the third user 110-3, without any limitation.

Further, 110-1, the second user 110-2, and the third user 110-3 may be any individual users or entities with a registered user account over the platform.

Further, the first user device 108-1, the second user device 108-2, and the third user device 108-3 can include a variety of computing systems, including but not limited to, a laptop computer, a desktop computer, a notebook, a workstation, a portable computer, a personal digital assistant, a handheld device and a mobile device capable of configuring a user interface of the social media system of the first user 116 and the second user 118 respectively.

Further, the network 106 may be a wireless network, a wired network or a combination thereof. The network 106 may be implemented as one of the different types of networks, such as intranet, local area network (LAN), wide area network (WAN), the internet, Wi-Fi, LTE network, CDMA network, and the like. Further, the network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

According to the first aspect, the server 102 is configured to configure the application interface of the platform within the user device 108 of the user 110. The server 102 includes a processing circuitry 104 is configured to receive an input from the first user device 108-1 to either generate a new NFT or upload an NFT from a wallet of the NFTs pre-owned by the first user 110-1. Further, the processing circuitry 104 is configured to generate an image associated with each NFT of the platform. The image includes plurality of images of different merchandise with the corresponding NFT on the merchandise. The process of generation of image is described later in this paper.

The processing circuitry 104 is further configured to present the NFTs and the associated image within the application interface on the display screen of the second user device 108-2. In one embodiment, the image is displayed underneath the associated NFT. In another embodiment, the image may pop-up in response to the touch operation by the second user 110-2 on the NFT displayed on the application interface.

The processing circuitry 104 is further configured to receive an input from the second user 110-2 on the displayed image through the second user device 108-2. The input from the second user 110-2 corresponds to the selection of the merchandise presented from the displayed image. Further, the processing circuitry 104 is configured to generate an information associated with the selected merchandise by the second user 110-2 and present the information to the third user 110-3 within the application interface in the third user device 108-3.

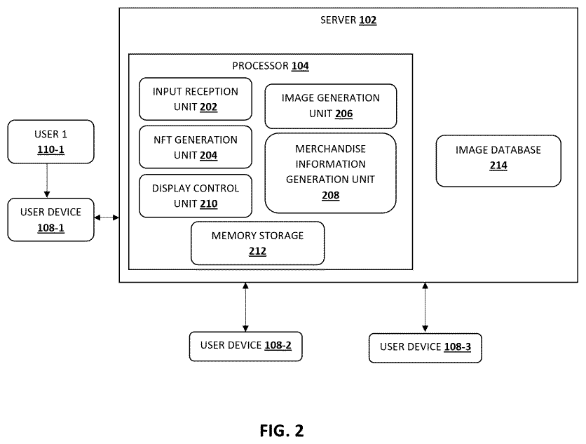

FIG. 2 is a block diagram that illustrates exemplary implementation of a system 100 for NFT-based merchandise sales, according to an embodiment of the present disclosure.

Referring to FIG. 2, the system 100 comprises a centralized server 102 having a processor 104. It is to be noted that the terms “processing circuitry 104” and the “processor 104” may be interchangeably referred hereinafter. The processor 104 further comprises an input reception unit 202, an NFT generation unit 204, an image generation unit 206, a merchandise information generation unit 208, a display control unit 210, and a memory storage 212 storing all these units. In one embodiment, the units may be hardware units on the processing circuitry 104. In another embodiment, the units may be an algorithm stored within the memory storage 212 for specific purposes and calculations.

Further, the server 102 may further include an image database 214. The image database may include a plurality of images of different commodities, images of commodities in different environments and/or backgrounds, images of commodities on different peoples, images of commodities with the imprinted NFTs, images of commodities in different angles, images of commodities in different sizes, and images of commodities in different colors, etc.

In one embodiment, the memory storage 212 may further include a trained model to generate the first image associated with the NFT. The first image includes images of plurality of different commodities with the associated NFT on each of the different commodities. The trained model may be trained using the images present within the image database 214 and the associated NFT created or uploaded by the first user 110-1 to generate the first image.

The processor 104 is configured to receive a first input from the first user 110-1 through the application interface of a platform configured within the first user device 108-1. The first input from the first user 110-1 includes an input for minting and creation of a first NFT, or an input for associating an existing NFT wallet with the platform. In one embodiment, the platform may provide the first user 110-1 with a module for creation and/or minting of the first NFT. In another embodiment, the platform may enable integration of the existing NFT wallet associated with the first user 110-1 to the platform. Based on the first input from the first user 110-1, the processor 104 stores the first NFT within a database (not shown) and presents the first NFT within the application interface in the second user device 108-2 associated with the second user 110-2.

The processor 104 is further configured to generate the first image associated with each of the NFTs displayed over the platform. In one embodiment, the first image may be displayed together with each NFT. In another embodiment, the first image may be displayed in a size smaller to the NFT below the NFT. In one another embodiment, the first image may pop-up when the second user 110-2 clicks on the NFT, or moves and/or holds the cursor over the NFT.

The first image may include images of plurality of commodities side-by side. The first image may further include the image of associated NFT over each commodity of the plurality of commodities. The first image may be generated to enable the second user 110-2 to purchase any commodity with the imprinted NFT of his/her choice when the second user 110-2 without purchasing the NFT.

In one embodiment, the first image is generated by the processor 104 using the plurality of images of different commodities present within the image database 214 and the NFT on the platform. In another embodiment, the first image may be generated by the learned model stored within the memory storage 212.

The processor is further configured to control a display screen of the second user device 108-2 associated with the second user 110-2 to display the platform with the plurality of NFTs and the associated first images. The platform is displayed within the application interface configured within the second user device 108-2 and displayed within the display screen.

Further, the processor is configured to receive an input from the second user device 108-2. The input corresponds to the selection of the at least one commodity from the first image by the second user 110-2. The input includes a touch operation by the second user 110-2 on the image of the at least one commodity within the first image presented over the second user device 108-2.

Further, the processor 104 is configured to generate an information associated with the selection of the second user 110-2. The information includes an information of the at least one merchandise with the associated NFT selected by the second user 110-2. Further, the information includes purchase information of the selected merchandise.

Further, the processor 104 is configured to control a display device of the third user device 108-3 which is associated with the third user 110-3 to display the generated information. Based on the generated information, the third user 110-3 may prepare the selected commodity with the imprinted NFT and deliver to the second user 110-2.

In one embodiment, the processor 104 may be further configured to monitor the payment for the commodity and distribute the amount between the third user 110-3 and the first user 110-1. The distribution to the first user 110-1 may be a royalty against the creation and/or ownership of the first NFT.

In one embodiment, the commodities may include garments, caps, souvenir, mugs, or any other product and/or object that can be printed with the first NFT.

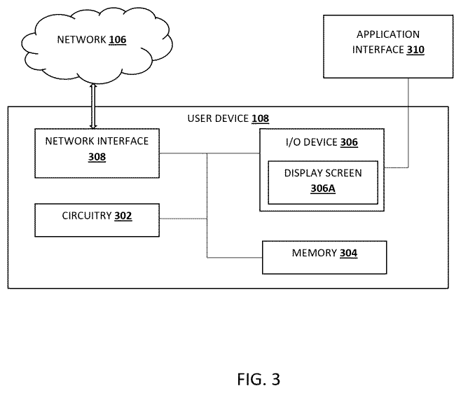

FIG. 3 is a block diagram that illustrates exemplary user device of the system, according to an embodiment of the present disclosure.

Referring to FIG. 3, the user device 108 is connected to the server 102 through a network 106. The user device 108 may include a circuitry 302, a memory 304, an I/O device 306, and a network interface 308. The circuitry 302 may be configured to receive an information and/or command from the server 102 and control the I/O device 306. The memory 304 may be configured to store the algorithm for the configuration and functioning of the platform. Further, the memory 304 may be configured to temporarily store the data of the associated user and/or the information received from the server 102. The input or output (I/O) device 306 may include a display screen 306A. The display screen 306A may be a touch sensitive display. Further, the I/O device 306 may be a keyboard, microphone, or a speaker. The display screen 306A may be configured to present an application interface 310 of the platform to the respective user associated with the user device 108. Further, the user device 108 may include the network interface 308 to connect the user device 108 with the network 106.

In one embodiment, the system for NFT-based merchandise sales comprises a control circuitry that is configured to provide a virtual platform within a user device of the creator to enable creation of a new art or upload existing art from a storage of the first user device over the virtual platform, mint the NFT from the created new art or uploaded existing art, display the minted NFT to a second user with associated merchandise data, receive a second input associated with a purchase of a merchandise corresponding to the NFT, notify the manufacture regarding the purchase order with associated data, calculate a commission amount for the creator, and distribute an amount between the creator and the manufacturer based on the calculated commission.

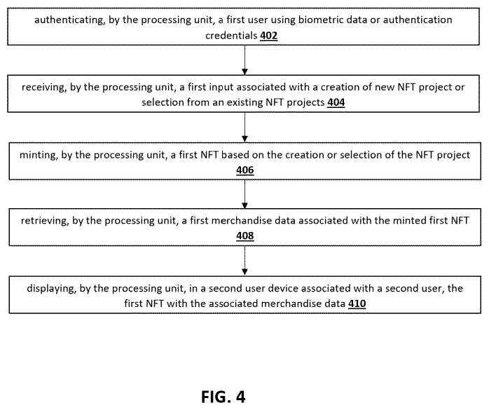

FIG. 4 is a flowchart of a method of creating and offering of an NFT and associated merchandise, according to an embodiment of the present disclosure.

Referring to FIG. 4, the method includes the step of authenticating, by the processing unit, a first user using biometric data or authentication credentials, as step 402.
receiving, by the processing unit, a first input associated with a creation of new NFT project or selection from existing NFT projects, as step 404.
minting, by the processing unit, a first NFT based on the creation or selection of the NFT project, as step 406.
retrieving, by the processing unit, a first merchandise data associated with the minted first NFT, as step 408.
displaying, by the processing unit, in a second user device associated with a second user, the first NFT with the associated merchandise data, as step 410.

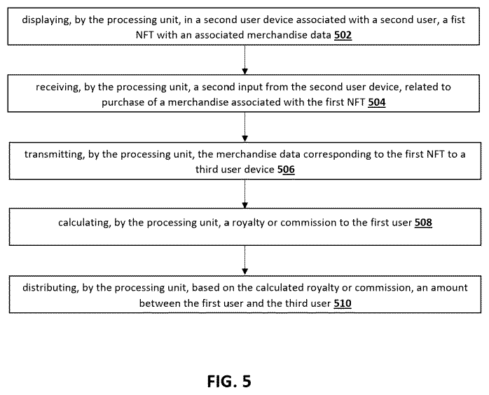

FIG. 5 is a flowchart of a method of distributing of revenue between the creator of NFT (first user) and manufacturer of merchandise (third user), according to an embodiment of the present disclosure.

Referring to FIG. 5, the method further includes steps of displaying, by the processing unit, in a second user device associated with a second user, a first NFT with an associated merchandise data, as step 502.
receiving, by the processing unit, a second input from the second user device, related to the purchase of merchandise associated with the first NFT, as step 504.
transmitting, by the processing unit, the merchandise data corresponding to the first NFT to a third user device, as step 506.
calculating, by the processing unit, a royalty or commission to the first user, as step 508.
distributing, by the processing unit, based on the calculated royalty or commission, an amount between the first user and the third user, as step 510.

According to one embodiment, the control circuitry of the system includes an authentication or access control module. The access control module may be configured to authenticate the creator, manufacturer, and user before accessing the virtual platform using their respective user device. The authentication may be performed by requesting personal user credentials or using a biometric signature associated with the user. The authentication may also be performed by sending a one-time verification code to the user's device and authenticating via the one-time verification code.

The system, once accessed by the creator/manufacturer/user, provides different user interface according to the type of the user. For instance, the system provides an interface to the creator to enable him/her to create a new artwork to be minted as NFT or allow him to upload any existing artwork from the storage device of the associated user device. Further, the system receives input from the creator to mint an NFT from the create new artwork or uploaded artwork.

The system, based on the received input from the creator, associates the created artwork with a token over a blockchain and generates the NFT. Further, the system displays that newly minted NFT over a virtual marketplace for interested users to purchase.

In one embodiment, the processing circuitry receives merchandise data from the creator to be associated with the NFT. For instance, the creator may offer certain merchandises with the NFT or only merchandise that is associated with the NFT. In another embodiment, the system enables the manufacturer of merchandise to offer one or more merchandise with imprinted NFT associated with the creator. The merchandise may be any physical world product without any limitation.

For the users of the virtual platform, the system presents an interface that enable the user to details of the NFT which includes image/s of NFT, details of creator, time of creation, previous ownerships, current value, etc. Further, the interface further displays a detail of any merchandise associated with the NFT being sold with or without ownership of the NFT. For instance, if the value of the ownership of NFT is high, the user may still order a commodity with imprinted NFT.

In an embodiment, the system includes an order processing and fulfilment control module for the manufacture allowing the manufacturers to track the order details from the user, receive a payment confirmation, and provide the order shipment details until the ordered commodity is reached to the user.

In one embodiment, the system includes commission calculation and payment module that calculates the commission for the creator/owner of the NFT and distributes payments accordingly between the NFT creator/owner and the commodity manufacturer.

In one embodiment, the system may associate a virtual wallet with accounts of the creators, users, and manufactures. Based on the value of the commodity, the system deducts amount from the wallet associated with the user into the wallets of creators and manufacturers based on the calculated commission.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

Similarly, structures and functionality presented as a single component may be implemented as separate components. These and other variations, modifications, additions, and improvements fall within the scope of the subject matter herein. In addition, the term “each” used in the specification does not imply that every or all elements in a group need to fit the description associated with the term “each”. For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that are issued on an application based hereon. Accordingly, the disclosure of the embodiments is intended to be illustrative, but not limiting, of the scope of the patent rights.

1. A device for NFT-based merchandise sales, comprising:
control circuitry configured to:
generate a first NFT based on a first input from a first user;
generate a first image comprising one or more merchandise with the generated first NFT on each merchandise of the one or more merchandise;
control a display device of a second user device to display the generated first image;
receive a second input from the second user device to select at least one merchandise of one or more merchandise, wherein
the second input is based on an operation of the second user on the first image;
generate information associated with the selected at least one merchandise by the second user; and
control a display device of a third user device to display the generated information associated with the selected at least one merchandise.

2. The device of claim 1, wherein the control circuitry is further configured to:
receive a third input from the first user; and
control the display device to display the first NFT on a user interface of the marketplace.

3. The device of claim 1, further comprises
an image database includes a plurality of images of the one or more merchandise.

4. The device of claim 3, wherein
the control circuitry is further configured to generate the first image based on the first NFT and the plurality of images from the image database.

5. The device of claim 4, wherein
the control circuitry is further configured to generate the first image based on the learned model.

6. The device of claim 1, wherein the operation of the second user includes a touch operation, swipe operation, drag operation, or click operation on at least one merchandise from the one or more merchandise in the first image.

7. The device of claim 1, wherein
the first input from the first user is at least to mint an NFT on a blockchain or associate an NFT wallet comprising one or more NFTs, and
the first user is an NFT creator or an owner.

8. The device of claim 1, wherein the information associated with the selected at least one merchandise is displayed as a notification, message, audio notification, or video notification.

9. The device of claim 8, wherein the notification includes details associated with the selected at least one merchandise with the first NFT.

10. The device of claim 9, wherein
the control circuitry is further configured to:
determine first price information of the selected at least one merchandise with the first NFT; and
generate second price information, wherein
the second price information corresponds to the commission amount for the first user.

11. The device of claim 1, wherein a third user is a manufacturer of the first merchandise corresponding to the first NFT.

12. A system for NFT-based merchandise sales, comprising:
a server comprising a control circuitry, wherein the control circuitry is configured to:
generate a first NFT based on a first input from a first user;
generate a first image comprising one or more merchandise with the generated first NFT on each merchandise of the one or more merchandise;
control a display device of a second user device to display the generated first image;
receive a second input from the second user device to select at least one merchandise of one or more merchandise, wherein
the second input is based on an operation of the second user on the first image;
generate information associated with the selected at least one merchandise by the second user; and
control a display device of a third user device to display the generated information associated with the selected at least one merchandise.

13. A method for NFT-based merchandise sales, comprising:
generating a first NFT based on a first input from a first user;
generating a first image comprising one or more merchandise with the generated first NFT on each merchandise of the one or more merchandise;
controlling a display device of a second user device to display the generated first image;
receiving a second input from the second user device to select at least one merchandise of one or more merchandise, wherein
the second input is based on an operation of the second user on the first image;
generate information associated with the selected at least one merchandise by the second user; and
control a display device of a third user device to display the generated information associated with the selected at least one merchandise.
